(19) United States
(12) Patent Application Publication
(10) Pub. No.: US 2008/0115212 A1
(43) Pub. Date: May 15, 2008

(54) Fuel cartridge authentication

(76) Inventors: Jeffrey Lynn Arias, Downey, CA (US); Gerhard Beckmann, Altamont, NY (US); Michael Otto Bigelow, Ellensburg, WA (US); Clive L. Dym, Claremont, CA (US); Laurel Harris Fullerton, Claremont, CA (US); Kenneth Brandon Maples, Los Angeles, CA (US); Michael Saldana, Claremont, CA (US); Yosuke Sato, Fujieda-city (JP); Wayne Chung Tanaka, Kaneohe, HI (US)

Correspondence Address: MINTZ, LEVIN, COHN, FERRIS, GLOVSKY AND POPEO, P.C;ATTN: PATENT INTAKE CUSTOMER NO. 64046, ONE FINANCIAL CENTER, BOSTON, MA, 02111, US

(21) Appl. No.: 11/800,060

(22) Filed: May 2, 2007

Related U.S. Application Data
(60) Provisional application No. 60/797,115, filed on May 2, 2006.

(51) Int. Cl. H04L 9/32

(52) U.S. Cl. 726/21

(57) ABSTRACT

Several interrelated methods are described for guaranteeing the authenticity of a fuel cartridge that will supply methanol, hydrogen, or other fuel to a fuel consuming device apparatus. Specific fuel consuming device constructions must mate with specially designed fuel cartridges to ensure that the fuel will flow properly, that the fuel supplied is of sufficient quality and composition as required, and that will be leak-proof during storage, transport, and use. Several designs that will meet all of these requirements are described below. Each of the fuel cartridge designs will result in an acceptance by the fuel consuming device if the authentication criteria are met and rejection of the cartridge if they are violated.

### RELATED APPLICATION

This application claims the benefit under U.S. Pat. App. Ser. No. 60/797,115, entitled “Fuel Cartridge Authentication,” filed May 2, 2006, the contents of which are hereby fully incorporated.

### TECHNICAL FIELD

The subject matter described herein relates to the field of fuel storage and more specifically to replaceable fuel cartridges that supply the fuel to fuel consuming devices such as fuel cells and the authentication or verification of such fuel cartridges.

### BACKGROUND

Portable devices are increasingly utilizing fuel consuming devices, such as fuel cells or combustion products, in order to generate heat or electricity, or to facilitate combustion. Fuel receptacles (such as fuel cartridges) can be detachably coupled to such fuel consuming devices to provide a source of fuel. Such fuel may comprise gases, liquids, or solids which are selectively released from the receptacles. In order to ensure that the fuel cartridges are from authorized sources that meet certain safety standards and/or legal obligations, such cartridges need to be authenticated.

### SUMMARY

In one aspect, a fuel cartridge comprises a housing (which may be unitary and/or injection molded) having a plurality of randomly dispersed protrusions on an outer surface, the housing being operable to couple to a fuel consuming device, the fuel consuming device comprising a pressure-activated keypad operable to read the randomly dispersed protrusions when the housing is coupled to the fuel consuming device, the fuel consuming device preventing a flow of fuel from the fuel cartridge to the fuel consuming device if the read randomly dispersed protrusions do not correspond to an authentication identifier.

In a first interrelated aspect, a fuel cartridge comprises a housing having a graphical element (e.g., logo, holographic label, etc.) on an outer surface, the housing being operable to couple to a fuel consuming device, the fuel consuming device comprising an optical sensor to scan the graphical element when the housing is coupled to the fuel consuming device, the fuel consuming device preventing a flow of fuel from the fuel cartridge to the fuel consuming device if the scanned graphical element does not meet predefined authentication criteria.

In a second interrelated aspect, a fuel cartridge comprises a housing having a crystal element on an outer surface, the housing being operable to couple to a fuel consuming device, the fuel consuming device comprising an optical sensor to detect light scattered from the crystal element when the housing is coupled to the fuel consuming device to determine the authentication identifier, the fuel consuming device preventing a flow of fuel from the fuel cartridge to the fuel consuming device if the scanned graphical element does not meet predefined authentication criteria. The crystal element may be made from at least one material selected from a group comprising: potassium titanyl phosphate potassium niobate, lithium triborate, silicon, sapphire, and quartz.

In a third interrelated aspect, a fuel cartridge comprises a housing having a chipless RFID tag, the housing being operable to couple to a fuel consuming device, the fuel consuming device comprising an RFID reader operable to read the RFID tag when the housing is coupled to the fuel consuming device, the fuel consuming device preventing a flow of fuel from the fuel cartridge to the fuel consuming device if the read RFID tag does not meet predefined authentication criteria.

In a fourth interrelated aspect, a fuel cartridge comprises a housing having at least one reflective element on an outer surface, the housing being operable to couple to a fuel consuming device, the fuel consuming device comprising an optical sensor operable to measure light reflected from the housing when the housing is coupled to the fuel consuming device, the fuel consuming device preventing a flow of fuel from the fuel cartridge to the fuel consuming device if the position and intensity of the reflected light does not meet predefined authentication criteria.

In a fifth interrelated aspect, a fuel cartridge comprises a housing having a plurality of randomly dispersed nano-bumps on an outer surface, the housing being operable to couple to a fuel consuming device, the fuel consuming device comprising a sensor operable to detect the nano-bumps when the housing is coupled to the fuel consuming device, the fuel consuming device preventing a flow of fuel from the fuel cartridge to the fuel consuming device if a positioning of the nano-bumps does not correspond to an authentication identifier.

In a sixth interrelated aspect, a fuel cartridge comprises a housing having at least one optical fiber on an outer surface, the housing being operable to couple to a fuel consuming device, the fuel consuming device comprising a light source and a detector operable to emit light to a first end of the at least one optical fiber and to detect light from a second end of the at least one optical fiber when the housing is coupled to the fuel consuming device, the fuel consuming device preventing a flow of fuel from the fuel cartridge to the fuel consuming device if an intensity or spot size of the detected light do not correspond to an authentication identifier.

In a seventh interrelated aspect, a fuel cartridge comprises a housing having a first portion of an electrical circuit accessible from an outer surface of the housing, the housing being operable to couple to a fuel consuming device, the fuel consuming device comprising a second portion of the electrical circuit to couple to the first portion of the electrical circuit when the housing is coupled to the fuel consuming device, the fuel consuming device including a frequency generating element operable to send a frequency sweep through the electrical circuit, the fuel consuming device preventing a flow of fuel from the fuel cartridge to the fuel consuming device if an amplitude of the detected frequency sweep does not correspond to an authentication identifier.

In an eighth interrelated aspect, a fuel cartridge comprises a housing having at least one radioactive tag on an outer surface, the housing being operable to couple to a fuel consuming device, the fuel consuming device comprising a sensor operable to characterize the radioactive tag when the housing is coupled to the fuel consuming device, the fuel consuming device preventing a flow of fuel from the fuel cartridge to the fuel consuming device if the characterized radioactive tag does not correspond to an authentication identifier.

Authenticated cartridges may also be used to monitor an amount of fluid flow into a fuel consuming device. In one implementation, fuel consumption with particular authenticated cartridges is monitored so that if such a cartridge is removed after all of the fuel has been delivered to the fuel consuming device, that cartridge cannot be reinserted (or a clone of such cartridge) into the fuel consuming device. Such an arrangement also ensures that cartridges that have been refilled by third parties with unsafe materials are not used (thereby avoiding leaks and damage to the fuel consuming device).

The variations described herein are methods for authenticating a cartridge of fuel. The fuel cartridge mates with a fuel cell (hydrogen, methanol, etc.) to provide a replaceable supply of fuel to the cell. To eliminate the possibility of unauthorized, defective, or unsuitable fuel cartridges being coupled to the fuel cell, the fuel cartridge must be amenable to some form of authentication process. This “mating” process assures that when fueled, the fuel cell will operate in a safe, reliable, and efficient manner. Variations described here rely on various techniques such as radioactive tags, fluorescing nano-bumps, nano-dots, or nano-mirrors, logo checking with conductive ink, Radio Frequency Identification (RFID) tagging, and optical detection methods using crystals, speckle patterns, or fiber optics. Such authentication technique can also be used with other devices/goods that may require authentication such as computer disks, printer cartridges, batteries, CDs, DVDs, identification badges, and the like.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 is a flow chart showing the general steps in the authentication of a fuel cartridge.

FIGS. 2A and 2B are schematics collectively showing a fuel cartridge design with bumps for authentication.

FIG. 3 is a schematic showing an optical reader detecting and authenticating the unique holographic label on the fuel cartridge.

FIG. 4 is a schematic illustrating how a company logo on the fuel cartridge is scanned and authenticated by an optical reader on the fuel cell side.

FIG. 5 is a schematic representation of the crystal authentication method.

FIGS. 6A and 6B are schematics collectively showing a chipless RFID tag on the fuel cartridge being authenticated by an optical reader on the fuel cell side.

FIG. 7 is a schematic showing security mirrors on the fuel cartridge being authenticated by an optical reader on the fuel cell side.

FIG. 8 is a schematic showing a laser beam shining on a pattern of nano-bumps on the fuel cartridge and resulting in a unique speckle interference pattern for authentication.

FIG. 9 shows the fiber optics embedded in the fuel cartridge being authenticated by an optical reader.

FIG. 10 is a schematic showing a frequency response authentication method.

FIG. 11 is a schematic of a radioactive tag authentication method.

Like reference numbers and designations in the various drawings indicate like elements.

### DETAILED DESCRIPTION

The following provides several interrelated related methods for insuring the authenticity of fuel cartridges and to prevent unsafe or illegal fuel cartridges from being mated to specific fuel cells. Each of the variations below specifies how the authentication process is validated by its specific design.

The subject matter described herein can prevent or minimize fuel cartridge counterfeiting, and preventing unauthorized fuel cartridge refilling. To accomplish these aims, factors may be implemented such as (1) identifying each individual fuel cartridge, (2) reading the identification when inserted into the (fuel cell) device, (3) recording authentic identification numbers within the user device, (4) recording the fuel consumption from the fuel cartridge, and/or (5) comparing the stored and read numbers and fuel consumed with a logic circuit to decide whether or not to allow the fuel-cell to “run” (e.g., by “unlocking” the fuel cartridge fuel-transfer function).

Various techniques for identifying the fuel cartridge can be used, such as bar codes, mechanical features on the cartridge such as notches or bumps, RFID tags, holographic labels. A corresponding mechanism of reading the fuel cartridge ID is required, such as photo-detectors, radio detectors, mechanical switches, etc. More detailed descriptions of these techniques are provided below.

In order to evaluate the authentication design alternatives, a list of metric parameters may be used. This may help the end user determine the suitability of each authentication solution to the proposed application. The metric parameters may be, but not limited to: cost to pirate, difficulty to crack, accuracy, repeatability, manufacturing costs, impact on the fuel cell or fuel cell system, impact on the fuel cartridge, required additional time to pass authentication, dead volume, injury risk, and tamper proof.

The metric “cost to pirate” may address the cost for counterfeit original fuel cartridges made by identified and selected manufacturers to create fuel cartridges that can bypass the authentication feature, either through complete replication or other methods. An important factor to consider in the evaluation of this metric may be the difficulty in reverse engineering the authentication feature or method. A proposed scoring system may be: a score of zero indicates a device that may be bypassed with a fuel cartridge completely lacking an authentication feature; a score of five (maximum score) to a counterfeited fuel cartridge which authentication feature cost is substantially larger than the cost for an authentic cartridge. The scoring assignment between zero and five can be deferred to the end user, but a proposed guidance could be: score of one to 20% of original cost for an authentic cartridge, score of 2 to 40% of original cost, score of three to 60% of original cost, and score of four to 80% of original cost.

The metric “difficulty to crack” may address the difficulty of bypassing the authentication system. The failure of this “cracking” operation is crucial for the success of the authentication system of the fuel cartridge. The proposed scoring guidance may be based on the resources needed for bypassing the system, with one point awarded for requiring expert knowledge in the scientific field, two additional points for requiring inside knowledge (such as database information), and two more points for requiring special equipment not commonly available in electronics convenient stores.

The “accuracy” and “repeatability” are other metrics than may be considered for the evaluation of the authentication method used. The first relates to the importance of preventing counterfeited cartridges with high accuracy in determining legitimate from illegitimate cartridges. The second relates to the precision in passing or not passing authentic or counterfeited cartridges, and how repeatable that same result can be with the same scope and conditions that the test was performed upon. Both metric parameters may be scored based on respective plot of the results obtained with different authentication methods and test conditions.

“Manufacturing costs” per authenticated cartridge may be another metric to take into consideration. Nowadays, for a manufacturer of fuel cartridges it may be very important to have a low cost or cost savings manufacturing policy or mentality when it comes to adding up needed or not as needed (but yet very nice to have) features to a certain device or system. Authentication is not an exception and keeping a low cost for this feature may be a manufacturing reward in the long product development. A first approach in providing guidance to score this metric may be as follows: score of five if the authentication feature represents less than $0.02 per cartridge; score of four if that is between $0.02 and $0.04 per cartridge; score of three if the cost is between $0.04 and $0.06 per cartridge; score of two if the cost is between $0.06 and $0.08 per cartridge; score of one if the cost is between $0.08 and $0.10 per cartridge; and score of zero if the cost is higher than $0.10 per cartridge.

The metric “Impact on the fuel cell” addresses any modification that the fuel cell manufacturers may require to accommodate or implement such authentication method or feature, such as, but not limited to: added electronic components, biasing or biased parts, added mechanical features, etc. Ensuring compatibility and reducing both manufacturing and maintenance costs can be considered as primary factors to determine the relevance of this metric. The lowest relevance may be determined by a high cost increase of the fuel cell due to the implementation of this authentication feature. In parallel, the same criteria (“impact on cartridge”) may apply to the fuel cartridge. Simplicity in modifications to the fuel cartridge may significantly contribute in reducing costs as well as the risk or likelihood of malfunction. A higher consideration can be given to this metric if there are no added parts, components or features with the implementation of the authentication system to the cartridge. As the complexity of added parts (and number of parts) increases, the relevance given to this metric will be lower.

Four more metrics may be identified in order to qualify and evaluate the authentication system: required additional time to pass authentication, dead volume, injury risk, and tamper proof. User-friendliness may be an important factor to consider by the end user of this fuel cartridge, and indirectly, of this authentication system. If the time required to pass the authentication is high, the metric “required additional time to pass authentication” may be given a low score. As an example only, this criteria may be followed by the end user: if time needed to pass the authentication system is up to 1 second, that will get the maximum score of five; 5 seconds, score of four; 10 seconds, score of three; 30 seconds, score of two; one minute, score of one; score of zero for more than one minute required to pass the authentication system.

If the authentication system requires space and occupies a considerable “dead volume” (adding up to more than 25% of dead volume to the fuel cartridge), this metric will be given a low score of zero; an addition of less than 25% will be given a score of two; if there is no substantial change in the dead volume, the score will be given a four; if no added volume is required, that can be considered as the perfect situation, given a score of five.

The evaluation of the authentication system in regards to the “Injury Risk” metric may be as follows: score of five if there is no risk when the authentication system is used; score of 2 if there is some risk with superficial danger (breakability, finger getting caught); score of zero if there is significant risk with acute danger (chocking hazards, poisoning, sharp edges).

The robustness or “tamper proof” of each authentication system design may be scored based on the need of tools to destroy or disable, but not necessarily bypass, the authentication system or feature. Base on this assumption, the score can be as follows: score of five if power tools are required (drill, saw, etc); score of four if tools with extreme strength are needed (crowbar, hammer, etc); score of three if the use of uncommon tools are needed disable the authentication feature; score of two if simple tools are required (pens, forks, etc); and score of zero if the authentication system or feature can be destroyed or disabled with fingers or teeth.

In order to evaluate the authentication design alternatives, the above mentioned list of metric parameters may be used. The best option or design may be as a result of a weighted score given to these metrics. An example may be as follows: cost to pirate, 15%; difficulty to crack, 15%; accuracy, 10%; repeatability, 5%; manufacturing costs, 15%; impact on the fuel cell or fuel cell system, 5%; impact on the fuel cartridge, 10%; required additional time to pass authentication, 5%; dead volume, 10%; injury risk, 5%; and tamper proof, 5%.

Authorized fuel cartridge numbers can be stored in the user device, such as on a dedicated chip or within the computer software or hardware (e.g., the stored ID numbers can be “burned” into a chip at the OEM's factory, or downloaded later by modem). The authorized ID numbers can be randomized to make counterfeiting more difficult. For example, only one out of every 10 numbers possible could be used. Numbers shipped to every retailer could also be randomized (i.e., non-sequential).

The amount of fuel consumed can be monitored using, for example, metering pumps, or time of (computer) operation on the fuel cell, translated into (approximate) fuel consumption. The approximate amount of fuel consumed from each fuel cartridge is recorded within the user device and accumulated until the recorded amount exceeds the original fuel cartridge capacity. Removal of the fuel cartridge would not “re-zero” the counter when the same fuel cartridge (with a previously recognized ID) is reinserted.

The fuel cartridge ID numbers can be compared to authorized numbers, and the fuel consumed can be compared to the fuel cartridge capacity, using, for example, an internal program on a separate device chip or embedded in the computer software. If the fuel cartridge ID or fuel amount do not match (indicating a counterfeit fuel cartridge or a refill), operation of the fuel cell can be terminated, for example, by a “locking” a fuel-transfer valve or by blocking power from the fuel-cell to the user device. In addition, a message can be displayed on a display on the device (computer screen) to alert the user.

Once a device (laptop computer) had consumed the maximum fuel capacity of a fuel cartridge, that ID number would not function again in that device. Data downloads could be further used to identify other “used” numbers and eliminate them from the available pool. This might be done periodically and automatically as part of an Original Equipment Manufacturer's (OEM's) software upgrade by modem, so as not to require any action by the device owner.

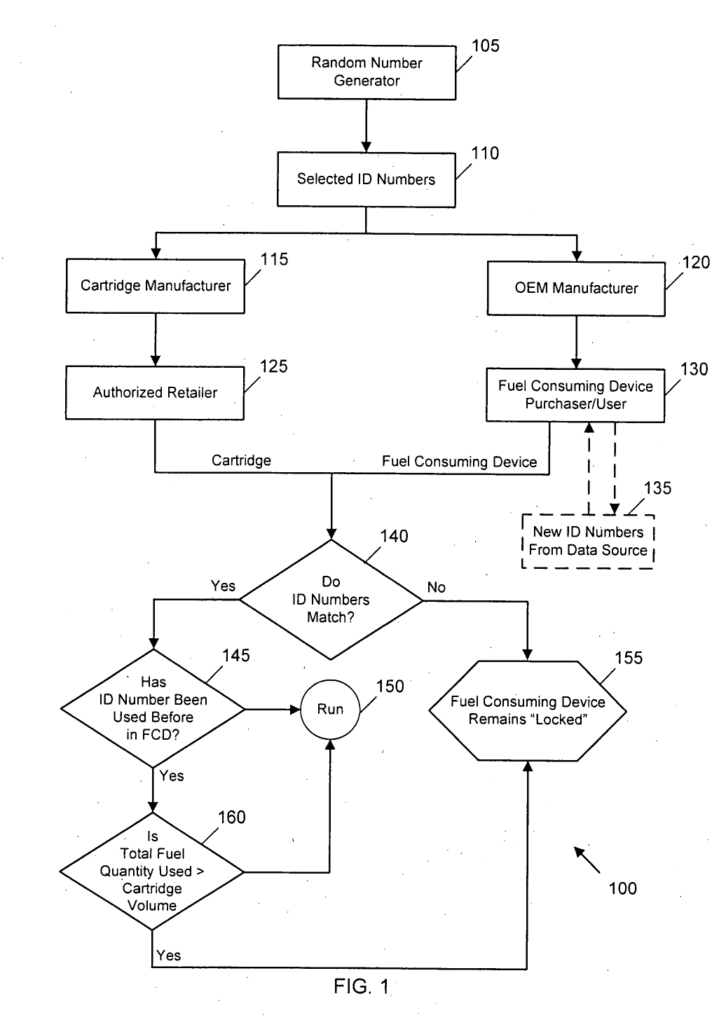

FIG. 1 is a process flow diagram illustrating a method 100 for authenticating a fuel cartridge. A random number generator 105 generates, at 110, a plurality of selected identification numbers. Thereafter, such numbers can be provided either to a cartridge manufacturer, at 115, or to an OEM manufacturer (e.g., a laptop manufacturer selling fuel cell powered computers), at 120. The cartridge manufacturer manufactures cartridges using the selected identification numbers and provides such cartridges, at 125, to an authorized retailer. In the other variation, the OEM manufacturer, at 130, provides the cartridges (along with the accompanying fuel consuming device) to an end-user. In some variations, the fuel consuming device may connect, at 135, to a remote data source, whether by modem or via a computer network such as the Internet, to obtain identifiers for authorized fuel cartridges. When the cartridge is inserted into a fuel consuming device, it is determined, at 140, whether the identifier associated with the cartridge matches an identifier associated with the fuel consuming device. If that is the case, then it is determined, at 145, whether the identification number had previously been used by the fuel consuming device. If that is not the case, then, at 150, the fuel is released into the fuel consuming device from the fuel cartridge. If that is the case, it is determined, at 160, whether the total amount of fuel used for that particular fuel cartridge has been wholly consumed. If that is not the case, then at 150, the fuel is released into the fuel consuming device from the fuel cartridge. Otherwise, the fuel consuming device, at 155, remains locked, and optionally, an indicator may be conveyed to a user indicating the same. Additionally, if the identifier numbers do not match, at 140, then the fuel consuming device, at 155, also remains locked.

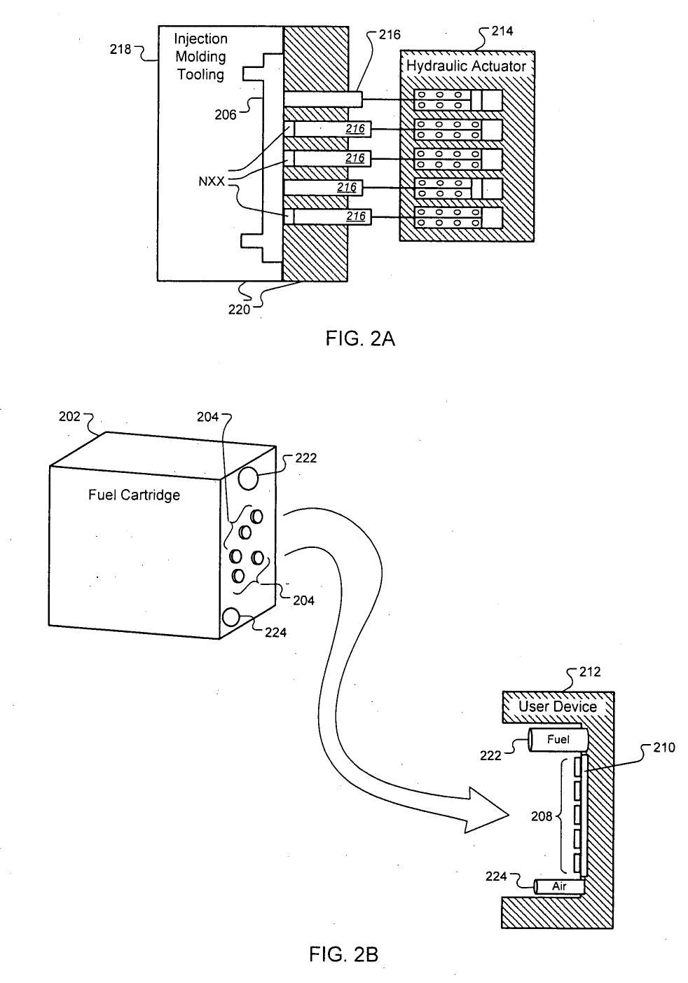

One variation of the fuel cartridge identification method is shown in FIGS. 2A and 2B, which collectively show a schematic of a fuel cartridge 202 design with bumps 204 for authentication. Such an arrangement uses an array of bumps 204 molded on a fuel cartridge end cap 206 which would depress locations 208 on a thin-film pressure-activated key pad 210 on a mating surface within a user device 212, as shown in FIG. 2B. The bumps 204 in the end cap 206 face can be produced by a hydraulic actuator 214 withdrawing hydraulically controlled pins 216 in an injection-molding tooling 218, as shown in FIG. 2A. The production process could use molded halves 220 to produce the bumps 204. The bumps 204 can be randomized, corresponding to the randomized authorized ID numbers. The bumps 204 would be sufficiently sized to fit between fuel transfer tubes 222 and air transfer tubes 224 of the fuel cartridge 202 and the fuel consuming device 210.

The reader in the device may be in stand by mode or similar energy conservation state when an authorized cartridge is not inserted. The reader can be initiated to authenticate a cartridge(s) when inserted into the device. The cartridges can possess a mechanical and/or electronic feature(s) that will engage or trigger a mating feature on the device. This action can turn on the reader and begin the authentication process.

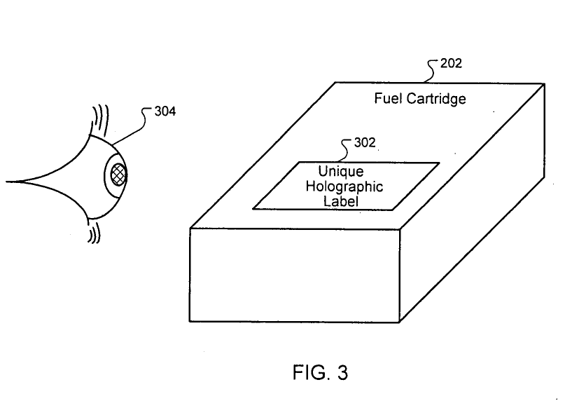

Another technique for authentication can utilize a holography-based process (FIG. 3) to produce a unique holographic label 302 on a fuel cartridge that is also tamper proof. Authentication is facilitated by an optical reader 304 within the fuel consuming device. Such a system is composed of a laser illuminator or a broadband source for “white light holograms” and a holographic reader.

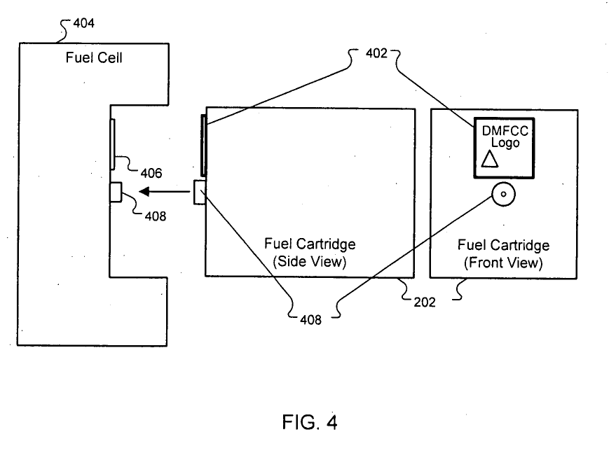

FIG. 4 is a schematic illustrating how a company logo on the fuel cartridge can be scanned and authenticated by an optical reader on the fuel consuming device side. This fuel cartridge authentication design uses a printed or stamped version of a logo 402 (e.g., 1 cm×1 cm) on the product label or side of the fuel cartridge 202 that interfaces with a fuel consuming device 404. The logo may be of any size smaller than the fuel cartridge 202, for example, about 1 cm×1 cm. When the fuel cartridge 202 is inserted into the fuel consuming device 404, an optical reader such as a photo sensor 406 in or on the fuel consuming device activates and scans the entire logo 402 for certain parameters including, but not limited to: logo size, coloring, shape, and lettering. Fuel would be allowed to flow through connector valves 408 from the fuel cartridge 202 to the fuel consuming device 404 only if authentication occurs.

To allow for greater manufacturing tolerance, the photo sensor 406 may scan a region larger than the logo itself and verify the logo by comparing relative letter size/position to that of a single letter (e.g., the “D” in DMFCC). Furthermore, specially pigmented inks may be used in the printing, with color verification enhancing this security feature. The photo sensor 406 may perform detection in one or more optical bands, such as visible, infrared, and ultraviolet.

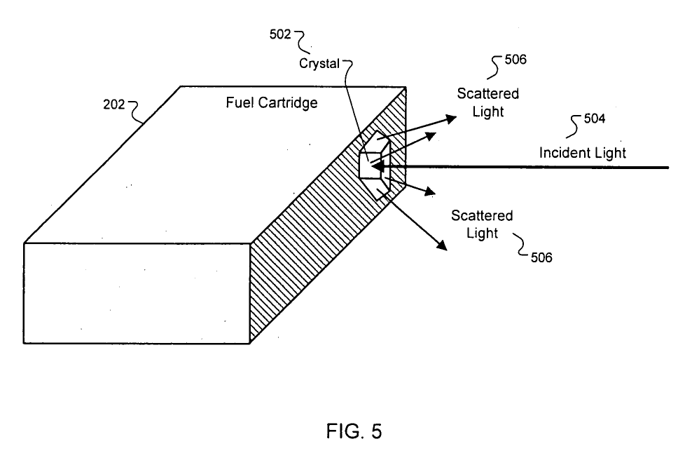

Another authentication technique (FIG. 5) relies on a small crystal 502 made from a non-water soluble, durable, and inexpensive material attached (partially embedded or glued on with an adhesive) to a small “test spot” on the fuel cartridge 202. Potential synthetic crystal materials include: potassium titanyl phosphate (KTP) potassium niobate (KN), lithium triborate (LBO), silicon, sapphire, and quartz. The fuel consuming device contains a detector that checks for the presence and authenticity of the crystal 502 by sending out incident light 504 such as a beam of coherent (laser) light and measuring how scattered light 506 reflects, refracts, or diffracts from the crystal; in some variations, the light may cause a fluorescent signature from the crystal. Due to their very nature, crystals have virtually no impurities and specific shapes, each crystal of a given material should have the same index of refraction and relative face orientation. Therefore, all crystals made from the same material and attached to the fuel consuming device 202 in the same orientation, will refract incident light 504 in the same way.

To enhance security, different crystallographic axes may be oriented toward the incident light source to produce differing refraction patterns. To make the cartridge more secure, more than one crystal can be used. If multiple crystals are arranged in a specific pattern with specific orientations, a unique, more complex, refraction pattern will be created.

In another variation, the crystals are randomly arranged across the “test spot” on the fuel cartridge 202. This will give each fuel cartridge 202 its own unique and difficult to replicate pattern. However, this requires the fuel consuming device to store a database of all authentic refraction patterns.

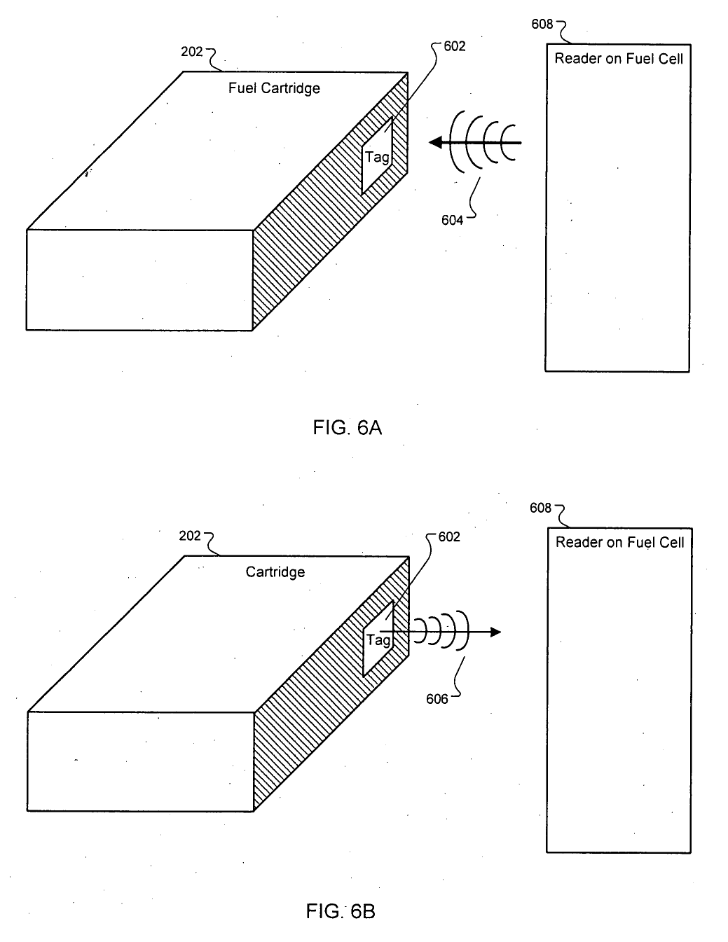

Another variation (FIGS. 6A and 6B) similar to crystal authentication employs a chipless RFID tag 602. The ID tag 602 can consist of RF fibers embedded in a label. When bombarded by coherent electromagnetic waves 604 (FIG. 6A), these fibers would reflect back (FIG. 6B) a specific interference pattern 606 that is read and verified by an external reader 608. A different ID tag 602 would consist of writing or a log printed with ink containing chemicals with specific magnetic properties that can be measured. For this tag, line-of-sight reading is not required, and the tag may even be on the inside of the cartridge. Other tags may contain microscopic bits of aluminum which reflect a specific interference pattern when bombarded by electromagnetic waves. Since all chipless RFID tags contain no actual circuitry, they are significantly less expensive than standard RFID tags. These tags are also more difficult to copy than standard barcodes. Furthermore, many chipless RFID tags do not require a line-of-sight for verification and can be embedded in non-metallic materials, making them even more difficult to detect and copy.

A chipless RFID label is applied to each fuel cartridge and each fuel consuming device is equipped with a reader. The design of these readers is well-known to those skilled in the art. When a fuel cartridge is inserted into the fuel consuming device, the fuel consuming device can emit a coherent pulse of electromagnetic waves at the cartridge and read the reflected interference pattern. If the pattern is correct, the fuel consuming device will activate and open the fuel cartridge to resume normal functioning.

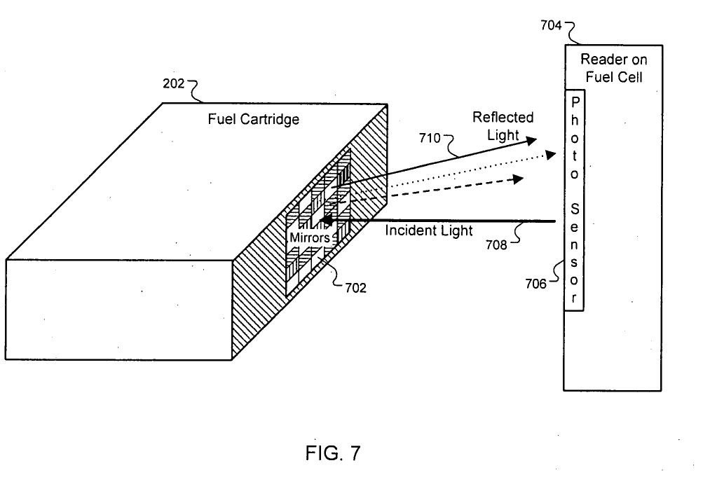

In another design approach (FIG. 7), a reflective label such as a “security mirror” 702 is attached to a small “test spot” on the outside of the fuel cartridge 202. A fuel consuming device reader 704 contains an active photo sensor 706 that checks for the presence of the security mirror 702 by shining light 708 (coherent or non-coherent) onto the test spot. If the security mirror 702 is present, the photo sensor 706 will detect reflected light 710 and communicate to the fuel consuming device that the fuel cartridge 202 is indeed authentic. The fuel cartridge 202 can be made even more difficult to copy by arranging multiple security mirrors 702 with differing amounts of reflectivity on the test spot. The reflectivity may be varied by the application of various thicknesses of anti-reflective coatings which are well-understood in the spectacle lens field. This increases the complexity of the test spot since a specific reflection pattern needs to be communicated to the photo sensor rather than a simple light intensity. The pattern could be random or a specific image (such as a company logo) so long as the photo detector knows what the proper pattern is. This design is similar to the crystal authentication approach; however, it uses reflection rather than refraction as a means of verification.

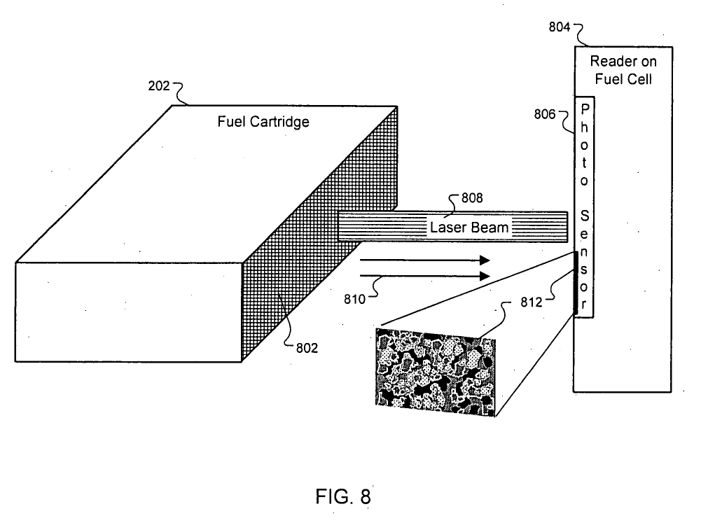

Another variation (FIG. 8) to authenticate a fuel cartridge 202 requires a pattern of microscopic nano-dots or nano-bumps 802 (e.g., small protrusions from a surface, etc.) to be printed on the surface of the fuel cartridge 202 using nano-printing technology. Nano-printing uses chemical etches or microscopic molds/presses to impart a specific pattern of nano-scale features onto a surface. Nano-printing can be done on plastics as well as metals. Since the fuel cartridge will likely be made out of plastic, the pattern will be printed in plastic. The pattern could be printed anywhere on the fuel cartridge that shares a line of sight with a reader in the fuel consuming device 804. This reader could include a photo sensor 806, a mechanical detector, or some other means of measuring the nano-bump pattern. The more complicated the pattern, the more secure the device is, since random nano-scale defects will be much less likely to match the authentic pattern. The pattern could also be the company logo, forcing counterfeiters to print the same logo on their cartridges and infringe trademark laws.

In one detection method for reading the pattern created by the nano-printing, an authentication device in the fuel consuming device shines a beam of coherent (laser) light 808 onto the pattern and uses the photo sensor 806 to detect the interference pattern generated by reflected light 810 interfering with itself (a technique known as Electronic Speckle Pattern Interferometry.) Light reflecting back from the tops of the bumps will have traveled a slightly shorter path than light reflecting from the bottom of the bumps. This difference in path length will cause the light reflecting from different parts of the bumps to be out of phase and combine differently with the incoming light. So long as the bumps have depths of the same order of magnitude as the incoming light (100 s of nanometers) they will create bright (positive interference) and dark (negative interference) “speckles” 812 in the light 810 reflecting from the fuel cartridge 202. Only authentic fuel cartridges will have the correct pattern of bumps on them, and thus, the proper “speckle” interference pattern.

In another variation, nano-dots are printed on the fuel cartridge and the fuel consuming device contains a light source (not necessarily coherent) which illuminates the dots, creating a specific fluorescent pattern which is recognizable by the cell.

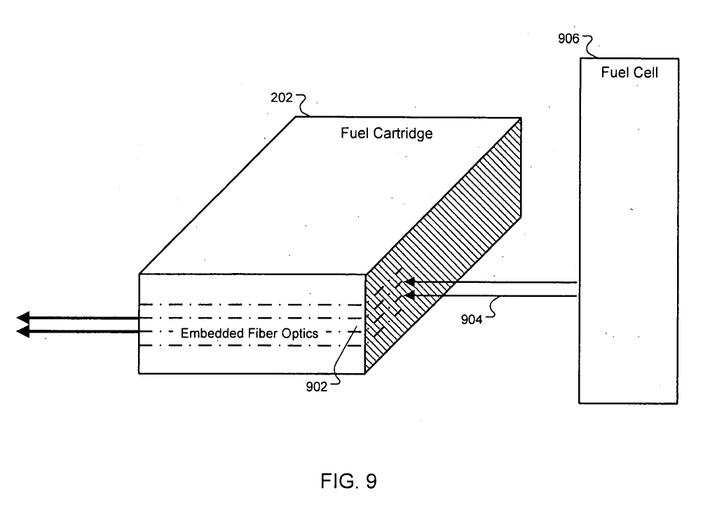

Another approach (FIG. 9) to authentication of a fuel cartridge 202 embeds optical fibers 902 in the outer casing of the fuel cartridge 202. A light source 904 (directed from a fuel consuming device 906) shining on the front of the fuel cartridge 202 illuminates the optical fibers 902 and is routed to the back or side of the fuel cartridge. This creates the false impression that light is being detected on the fuel cartridge's front adjacent to the light source on the fuel consuming device, when it is actually being detected elsewhere. This design also allows for the outgoing light to form a secure code by arranging the ends of the fiber optics into a pattern. This pattern can either be a random arrangement of fiber signatures (intensity, spot size, etc.), giving each cartridge a unique, difficult-to-replicate, pattern, or a specific pattern is universally used, giving each cartridge the same verification pattern.

The light pattern emitted from the ends of the fiber optics is channeled toward a detector in or on the fuel consuming device itself, where it is measured and authenticated by comparison with a stored pattern.

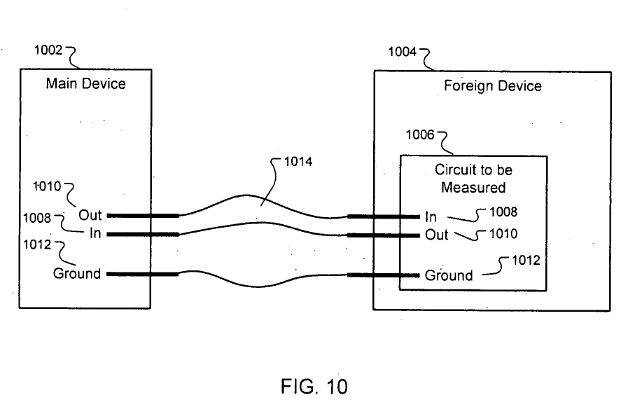

In another variation, a trusted (“main”) device 1002 can be used to verify the authenticity of a different (“foreign”) device 1004 by measuring the characteristics of an electrical circuit 1006 embedded in the foreign device, as shown in FIG. 10. Three terminals corresponding to input (“in”) 1008, output (“out”) 1010, and ground 1012 must be placed on the main and foreign devices 1002 and 1004 so that when the devices are fastened together by wires 1014, an electrical and mechanical connection is made. The main device 1002 sends a frequency sweep with constant amplitude from 1 GHz to 100 GHz between the in and ground terminals 1008 and 1010. By measuring the amplitude of the signal between out and ground as the sweep is sent, the frequency response of the circuit inside the foreign device can be measured. If the frequency response does not match the expected response within manufacturing tolerances, the foreign device is rejected.

Although the chosen frequency response of the device is insignificant, the procedure can be simplified by selecting a response that can be measured at three significant frequencies. For example, using a band-stop circuit, the main device could restrict its transmitted signal to three different frequencies corresponding to a frequency below, at, and above the attuned band. In this way, the device to be measured could allow for significant variation in the resistance, capacitance, and inductance of components.

Because the measurements are made at extremely high frequencies, discrete components are not necessary to have significant reactive effects. Instead, the layout of the circuit can cause reactive effects when the traces of the circuit are made into small loops and spirals. Therefore, the entire circuit can be made from a single print of a conductive material, such as copper, onto a standard resistive backing. The backing must not allow for capacitive effects to interfere with circuit performance.

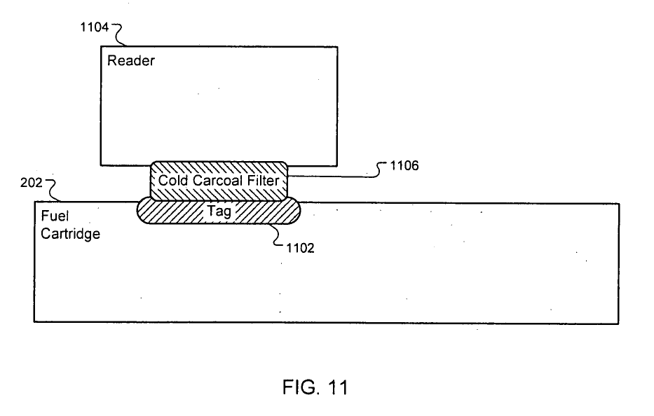

To authenticate the validity and age of a fuel cartridge 202 that may be resold or that changes hands many times, a radioactive tag 1102, such as carbon 14, calcium 45, chromium 51, or indium, may be used (FIG. 11). The tag 1102 could be printed in a unique way, varying shape, size, or form, to enhance security. A reader 1104 built into the fuel consuming device would perform an authenticity check for the presence and type of radioactive material and the tag's physical characteristics. The authentication check could be facilitated using a cold charcoal filter 1106. If too much decay has taken place, the amount of radioactive substance would fall below some pre-set threshold; therefore, the tag will not emit the proper amount of radiation, signaling that the unit needs to be replaced. If the wrong type of material is detected the unit will be rejected.

The tag 1102 would provide a fast and accurate way to determine the age and authenticity of the item under investigation, and is not easily replicated without the proper permits. Thus, pirating these tags would be difficult due to the controls in place on these materials. The tags would be small enough to be inexpensive, and the scanners have long lifetimes.

While the foregoing is described in connection with the authentication of fuel cartridges, the subject matter described herein can also be applied to any receptacle containing fuel or other material that may need to be authenticated. In addition, the authentication techniques described herein can be used in connection with goods/devices such as computer disks, printer cartridges, batteries, CDs, DVDs, identification badges, and the like.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. Other embodiments may be within the scope of the following claims.

What is claimed is:

1. A fuel cartridge comprising:
a housing having a plurality of randomly dispersed protrusions on an outer surface, the housing being operable to couple to a fuel consuming device, the fuel consuming device comprising a pressure-activated keypad operable to read the randomly dispersed protrusions when the housing is coupled to the fuel consuming device, the fuel consuming device preventing a flow of fuel from the fuel cartridge to the fuel consuming device if the read randomly dispersed protrusions do not correspond to an authentication identifier.

2. A fuel cartridge as in claim 1, wherein the housing is unitary and injection molded.

3. A fuel cartridge comprising:
a housing having a graphical element on an outer surface, the housing being operable to couple to a fuel consuming device, the fuel consuming device comprising an optical sensor to scan the graphical element when the housing is coupled to the fuel consuming device, the fuel consuming device preventing a flow of fuel from the fuel cartridge to the fuel consuming device if the scanned graphical element does not meet predefined authentication criteria.

4. A fuel cartridge as in claim 3, wherein the graphical element comprises a holographic label.

5. A fuel cartridge comprising:
a housing having a crystal element on an outer surface, the housing being operable to couple to a fuel consuming device, the fuel consuming device comprising an optical sensor to detect light scattered from the crystal element when the housing is coupled to the fuel consuming device to determine the authentication identifier, the fuel consuming device preventing a flow of fuel from the fuel cartridge to the fuel consuming device if the scanned graphical element does not meet predefined authentication criteria.

6. A fuel cartridge as in claim 5, wherein the crystal element is made from at least one material selected from a group comprising: potassium titanyl phosphate potassium niobate, lithium triborate, silicon, sapphire, and quartz.

7. A fuel cartridge comprising:
a housing having a chipless RFID tag, the housing being operable to couple to a fuel consuming device, the fuel consuming device comprising an RFID reader operable to read the RFID tag when the housing is coupled to the fuel consuming device, the fuel consuming device preventing a flow of fuel from the fuel cartridge to the fuel consuming device if the read RFID tag does not meet predefined authentication criteria.

8. A fuel cartridge comprising:
a housing having at least one reflective element on an outer surface, the housing being operable to couple to a fuel consuming device, the fuel consuming device comprising an optical sensor operable to measure light reflected from the housing when the housing is coupled to the fuel consuming device, the fuel consuming device preventing a flow of fuel from the fuel cartridge to the fuel consuming device if the position and intensity of the reflected light does not meet predefined authentication criteria.

9. A fuel cartridge comprising:
a housing having a plurality of randomly dispersed nano-bumps on an outer surface, the housing being operable to couple to a fuel consuming device, the fuel consuming device comprising a sensor operable to detect the nano-bumps when the housing is coupled to the fuel consuming device, the fuel consuming device preventing a flow of fuel from the fuel cartridge to the fuel consuming device if a positioning of the nano-bumps does not correspond to an authentication identifier.

10. A fuel cartridge comprising:
a housing having at least one optical fiber on an outer surface, the housing being operable to couple to a fuel consuming device, the fuel consuming device comprising a light source and a detector operable to emit light to a first end of the at least one optical fiber and to detect light from a second end of the at least one optical fiber when the housing is coupled to the fuel consuming device, the fuel consuming device preventing a flow of fuel from the fuel cartridge to the fuel consuming device if an intensity or spot size of the detected light do not correspond to an authentication identifier.

11. A fuel cartridge comprising:
a housing having a first portion of an electrical circuit accessible from an outer surface of the housing, the housing being operable to couple to a fuel consuming device, the fuel consuming device comprising a second portion of the electrical circuit to couple to the first portion of the electrical circuit when the housing is coupled to the fuel consuming device, the fuel consuming device including a frequency generating element operable to send a frequency sweep through the electrical circuit, the fuel consuming device preventing a flow of fuel from the fuel cartridge to the fuel consuming device if an amplitude of the detected frequency sweep does not correspond to an authentication identifier.

12. A fuel cartridge comprising:
a housing having at least one radioactive tag on an outer surface, the housing being operable to couple to a fuel consuming device, the fuel consuming device comprising a sensor operable to characterize the radioactive tag when the housing is coupled to the fuel consuming device, the fuel consuming device preventing a flow of fuel from the fuel cartridge to the fuel consuming device if the characterized radioactive tag does not correspond to an authentication identifier.

13. A method comprising:
identifying a fuel cartridge before delivery of fuel to a fuel consuming device, the fuel consuming device monitoring an amount of fuel delivered by the fuel cartridge;
determining whether the fuel cartridge meets certain predetermined authentication criteria based on the identification; and
limiting delivery of fuel by the fuel cartridge if the fuel cartridge does not meet the predetermined authentication criteria or if the monitored amount of fuel exceeds a predetermined amount; or
allowing delivery of fuel by the fuel cartridge if the fuel cartridge meets the predetermined authentication criteria or if the monitored amount of fuel does not exceed a predetermined amount.
